(19) United States
(12) Patent Application Publication
(10) Pub. No.: US 2009/0255123 A1
(43) Pub. Date: Oct. 15, 2009

(54) Razor with blade heating system

(76) Inventors: Louis D. Tomassetti, Pompano Beach, FL (US); William Bohmer, Randolph, NJ (US)

Correspondence Address: ROBERT M. DOWNEY, P.A., 6751 N. FEDERAL HWY., SUITE 300, BOCA RATON, FL, 33487, US

(21) Appl. No.: 12/082,840

(22) Filed: Apr. 15, 2008

(51) Int. Cl. B26B 21/48

(52) U.S. Cl. 30/34.05

(57) ABSTRACT

In a razor having a handle and a blade cartridge containing one or more blades, a system is provided for selectively heating the blades to a controlled temperature range. The blade heating system includes an electric circuit with a battery power source for controlled direction of current flow through the one or more blades in order to heat the blades. The electric circuit further includes an on/off switch, a visual indicator for indicating on/off status, a heat controller for selectively adjusting the temperature of the blades, and an automatic turn off switch for opening the circuit after an elapsed period for preserving battery life. In one embodiment, all of the components of the electric circuit are housed on the blade cartridge, with the battery power source, switches and heat controller contained within a waterproof casing. In another embodiment, all of the components of the electric circuit, with the exception of the one or more blades, are carried in the handle of the razor and an inductive coupling is provided at the connection of the handle and blade cartridge for electrically connecting the one or more blades to the electric circuit.

### BACKGROUND OF THE INVENTION

1. Field of the Invention

The present invention relates generally to razors for shaving and, more particularly, to a battery powered system in a razor for controlled heating of one or more blades of the razor.

2. Discussion of the Related Art

It is well known that hairs are softened and easier to cut when they are heated just prior to being cut by the sharp cutting edge of a razor blade. It is also known that the cutting edge of the razor blade is more effective in cutting hairs when the blade is warm or hot. Just prior to shaving, most people warm the hairs and skin with hot water or a hot towel. It is also common practice to place the shaver under hot running water in order to heat the blades just prior to stroking the blades over the skin in order to cut the hairs. However, the heat cutting performance of the blades lasts only a short time during the beginning of the shaving stroke. Within seconds, the temperature of the skin surface, hairs and blade are quickly reduced due to exposure to the ambient air temperature. Ideally, it is best to maintain the blades warm or hot throughout the shaving process.

One particular prior art blade heating invention, disclosed in U.S. Pat. No. 6,817,101 B1 to Bohmer, provides a shaving system with a continuously heated blade cartridge throughout the shaving stroke. Heating the blades is attained by applying a measured amount of electric current to the blade cartridge by means of conductors connected to each side of the blade cartridge and extended in the form of contacts at the connection of the blade cartridge to a razor handle. Electric current is provided by a primary battery contained in a waterproof compartment in the razor handle. Current provided by the battery renders optimum heat generation in the blades in the cartridge and can be adjusted by means of resistors in series with the blade and blade cartridge. A momentary contact switch closes the circuit and is operated by the user during the shaving stroke.

The present invention improves upon the shaving system disclosed in U.S. Pat. No. 6,817,101 B1 and provides for a heat controller for allowing the user to selectively adjust the heated temperature of the blades for desired comfort and optimum blade cutting efficiency. The present invention further provides for a visual indictor, such as an LED, to indicate on and off status of the blade heating system. A further improvement provided by the present invention is an automatic turn-off switch, in addition to a user controlled on/off switch, for automatically turning the heating system off after use of the razor in the event the user fails to operate the on/off switch, thereby preserving battery life. Additionally, the heat controller may be combined with a vibration feature for additional shaving comfort. A further improvement provides for a total “onboard” heating system in a disposable blade cartridge, thereby providing for controlled heating of blades in disposable blade cartridges for use on conventional razor handles.

### SUMMARY OF THE INVENTION

In a razor having a handle and a removable blade cartridge containing one or more blades, a system is provided for selectively heating the blades to a controlled temperature range. The blade heating system includes an electric circuit with a battery power source for controlled direction of current flow through the one or more blades in order to heat the blades. The electric circuit further includes an on/off switch, a visual indicator for indicating on/off status, a heat controller for selectively adjusting the temperature of the blades, and an automatic turn off switch for opening the circuit after a predetermined period of time has elapsed in order to preserve battery life. In one embodiment, all of the components of the electric circuit are housed on the blade cartridge, with the battery power source, switches and heat controller contained within a waterproof casing. In another embodiment, all of the components of the electric circuit, with the exception of the one or more blades, are carried in the handle of the razor and an inductive coupling is provided at the connection of the handle and blade cartridge for electrically connecting the one or more blades to the electric circuit.

### OBJECTS AND ADVANTAGES OF THE INVENTION

Considering the foregoing, it is a primary object of the present invention to provide a blade heating system in a razor that allows for controlled adjustment of the heated temperature of one or more blades in the blade cartridge of the razor.

It is a further object of the present invention to provide a blade heating system in a razor for controlling the heated temperature of one or more blades in the blade cartridge of a razor, and wherein the heated temperature level is visually indicated on a display.

It is still a further object of the present invention to provide a blade heating system for a razor that is contained entirely within a disposable blade cartridge.

It is still a further object of the present invention to provide a heating system in a razor for heating one or more blades in the blade cartridge of the razor and including a visual indicator for indicating an on and off status of the heating system.

It is still a further object of the present invention to provide a heating system in a razor for heating one or more blades in the razor cartridge and including an automatic turn off switch for turning the heating system off after use, thereby preserving battery life.

These and other objects and advantages of the present invention are more readily apparent with reference to the following detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a top perspective view of a first embodiment of the present invention including a disposable blade cartridge with an onboard blade heating system and a razor handle connected to the blade cartridge;

FIG. 1A is an isolated top plan view, taken along the plane of the line 1A-1A in FIG. 1, showing the blade cartridge with the onboard heating system and a concave scoop formation at the top end of the handle;

FIG. 1B is a front elevational view showing the blade cartridge of the embodiment of FIG. 1 with running water from a faucet being directed onto the concave scoop for flushing debris from the blades;

FIG. 2 is a top plan view, partially exploded, showing a second embodiment of the invention wherein a battery power source, switches, a heat controller, and a heat indicator are carried in the handle of the razor for directing controlled electric current flow through the one or more blades in the blade cartridge of the razor in order to heat the one or more blades to a selected temperature level within a predetermined temperature range;

FIG. 2A is an isolated top plan view taken along the plane of the line 2A-2A in FIG. 2;

FIG. 3 is an isolated top plan view illustrating connection of the razor handle to the blade cartridge according to the embodiment of FIG. 2;

FIG. 4 is a general schematic diagram showing one embodiment wherein the blades of the razor are electrically connected in parallel;

FIG. 5 is a general schematic diagram showing another embodiment wherein the blades are electrically connected in series;

FIG. 6 is a general schematic diagram showing the electrical connection of the blades in parallel with a center tap connection;

FIG. 7 is a general schematic diagram showing the electrical connection of the blades in series with a center tap connection;

FIGS. 8A-8C illustrate a sequence of operation of a slide switch to control current flow through the blades connected in parallel in accordance with one embodiment of the heat controller;

FIGS. 9A-9C illustrate a sequence of operation of a slide switch for controlling current flow through the blades connected in series in accordance with a further embodiment of the heat controller;

FIG. 10 is a general schematic diagram illustrating an inductive connection between the blade cartridge and the handle, in accordance with the embodiment of FIG. 2, wherein the battery power source and components are contained within the handle;

FIG. 11 is an isolated perspective view showing a further embodiment of the blade configuration comprising a continuous conductive razor blade folded into 4 parallel blades;

FIGS. 12A-12D illustrate a sequence of operation of a pulsating switch in accordance with a further embodiment of a heat controller for controlling the temperature of the heated blades;

FIG. 13 is an exploded perspective view showing one embodiment of a battery recharging device defined by a tray that plugs into an electrical outlet, and wherein the cradle of the tray is provided with spring loaded contacts for engagement with corresponding contacts on the handle of the razor;

FIG. 14 is a perspective view showing another embodiment of a battery recharging device, wherein an electrical cord plugs into an electrical outlet and an opposite end of the cord connects to a port in the handle of the razor for providing electric current to recharge one or more rechargeable batteries in the handle of the razor;

FIG. 15 is a perspective view showing a further embodiment of a battery recharging device defined by a tray that plugs into an electrical outlet, and wherein the cradle of the tray and the handle of the razor are provided with an inductive coupling to provide a waterproof connection for charging an internal rechargeable battery within the handle of the razor;

FIG. 16 is yet a further embodiment of the battery recharging device in the form of a tray, and wherein the tray includes an arrangement of light collecting panels for converting light energy to electric power for recharging a rechargeable battery within the handle of the razor;

FIG. 17 is a perspective view of yet a further embodiment of a battery recharging device, wherein the handle of the razor is provided with an arrangement of light collecting panels for converting light energy into electric power for recharging an internal rechargeable battery within the handle of the razor.

Like reference numerals refer to like parts throughout the several views of the drawings.

### DETAILED DESCRIPTION OF THE PREFERRED EMBODIMENTS

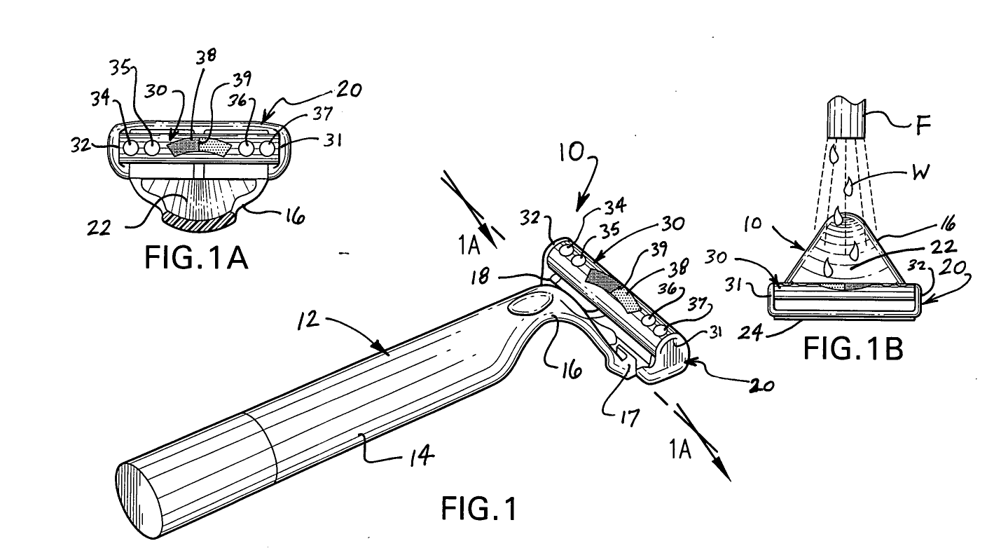

Referring initially to FIGS. 1-1B, a first embodiment of the razor with a blade heating system is shown and is generally indicated as 10. The razor 10 includes a handle 12 with an elongate grasping portion 14 and an integral neck 16. The neck is provided with connecting members 17, 18 on opposite sides for pivotal connection to a blade cartridge 20. The blade cartridge 20 may be affixed to the handle in a manner wherein the entire razor 10 is disposed of after several uses for shaving. Alternatively, the blade cartridge 20 may be removably attachable to the connecting members 17, 18 of the neck 16 wherein the blade cartridge is separated from the handle 12 and discarded after several uses when the blades begin to dull. Thereafter, a new blade cartridge 20 can be attached to the handle 12.

The handle 12 of the embodiment of FIGS. 1-1B may contain a pressurized charge of shave cream or gel for dispensing in a manner similar to that disclosed in U.S. Pat. No. 5,070,611 to Derin et al. Alternatively, the handle 12 may be of any conventional type that is well known in the razor industry or a newly designed handle, such as an ergonomically shaped handle that may contain shave cream or gel for dispensing therefrom.

In a preferred embodiment, the handle 12 of the razor 10 in the embodiment of FIGS. 1-1B is specifically designed to include a concave top surface 22 on the neck portion extending towards the blade cartridge 20. This concave top surface 22, defining a scoop or channel, is specifically structured and configured for directing a stream of water flow through the blade cartridge 20, below a battery housing, and between the blades 24, to thereby rinse debris (e.g., cut hairs, shaving cream, skin particles, etc.) from the blade surfaces. As seen in FIG. 1B, rinsing of the blades 24 can be achieved by holding the blade cartridge 20 and, more particularly, the concave top surface 22 of the neck below a running stream of Water from a Faucet. The stream of water from the faucet strikes the concave top surface 22 and flows, in a highly directional stream, through the blade cartridge 20 and between the blades 24.

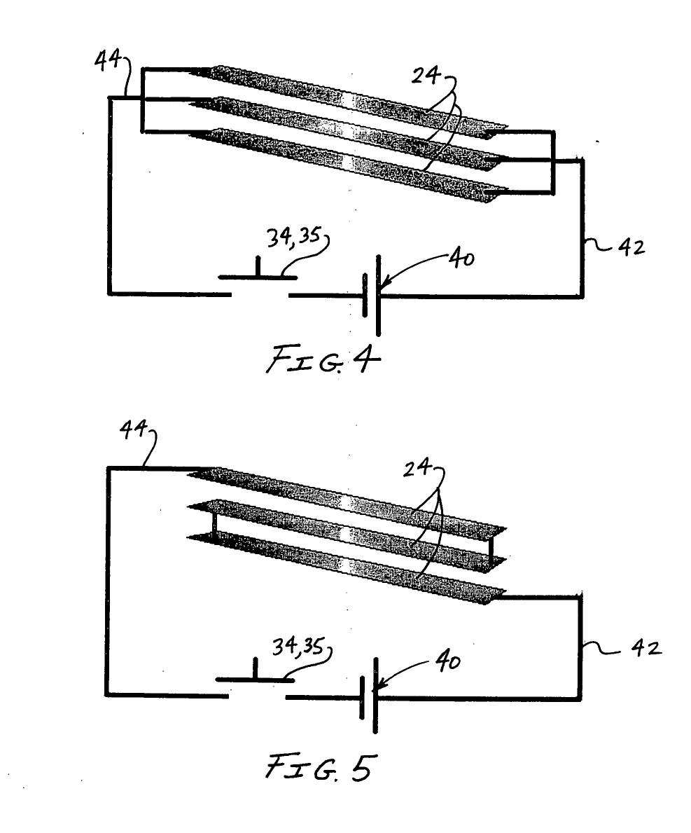

The onboard heating system in the embodiment of FIGS. 1-1B is contained within a water-tight housing 30 on the blade cartridge 20, defining a bridge structure extending over the blades 24. As seen in FIGS. 1-1B, the water-tight housing 30 includes a transverse structure, extending substantially across the length of the blade cartridge, from a right end to a left end. The transverse structure may be cylindrical, as shown, and is integrally molded or attached to opposite end walls 31, 32, at the right and left ends of the blade cartridge 20. The transverse water-tight housing structure 30 contains a battery power source for providing electric current flow through the circuit of the blade heating system, and particularly through the blades 24 in the blade cartridge. In the preferred embodiment, controls are provided on the water-tight housing 30 and include an ON switch 34, and OFF switch 35, and temperature control switches. The temperature control switches include an increase temperature switch 36 and a decrease temperature switch 37 for adjusting the heated temperature of the blades. A temperature indicator 38 on the housing displays the adjusted temperature level of the heated blades. In a preferred embodiment, the temperature indicator 38 is a temperature sensitive multi-color display that is reactive to heat generated as a result of the resistance of current flow through the circuit, and particularly through the blades 24 in the blade cartridge 20. As seen in FIG. 1, the indicated temperature is determined by a border 39 between a darker area of the display and the lighter color area of the display. This border 39 or transition between the dark area and light area on the display moves from left to right as the temperature of the blades increases. More specifically, warm temperatures are indicated when the border 39 on the multi-color display is towards the left side, while hotter temperatures are indicated as the border 39 moves towards and across the right side of the display, with the hottest temperature being at the point where the border 39 reaches the far right side of the display. Electric current flow through the blades 24 is achieved by electrical conductors 42, 44 connecting at opposite ends of the blades and to the positive and negative terminals of the battery source 40 (see FIGS. 4 and 5) contained within the water-tight housing 30. The conductors 42, 44 may be connected to the blades 24 in parallel or series. Examples of the parallel and series blade connections in the circuit are shown in FIGS. 4-9C, as described in more detail hereinafter. The blade heating system circuit may further be provided with a timer or other device (e.g., a tilt switch) for opening the circuit, thereby deactivating (i.e., turning off) the blade heating system, in the event the user forgets to turn the blade heating system off by pressing the OFF switch 35 on the water-tight housing. In this instance, the circuit will be opened, thereby turning off the blade heating system, after a predetermined period of time has lapsed or by some other action (e.g., a tilt switch) that is normally performed when a user has completed the shaving process.

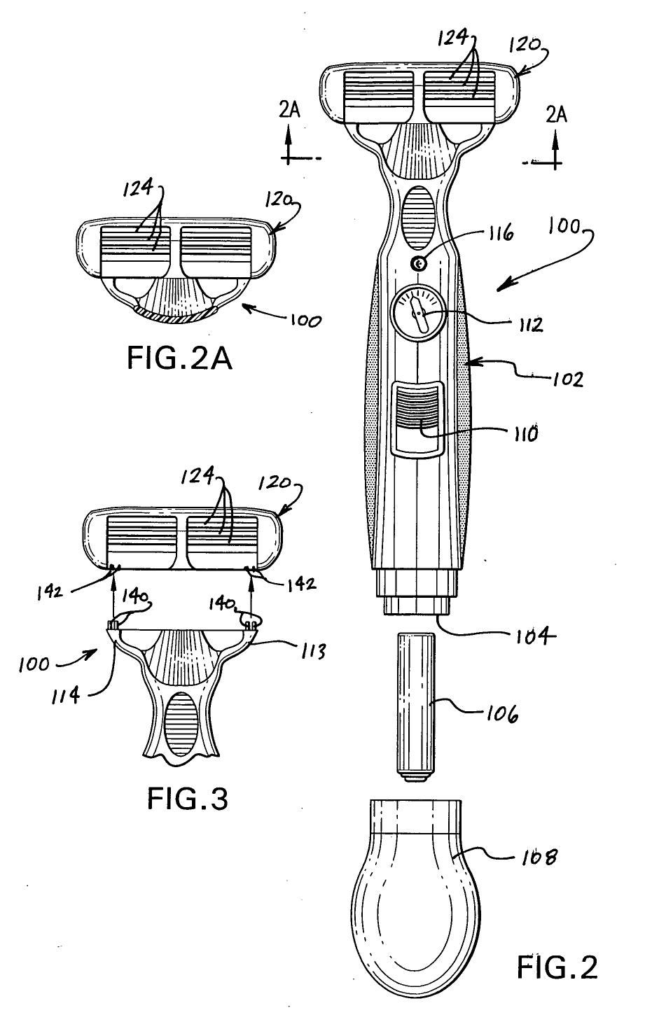

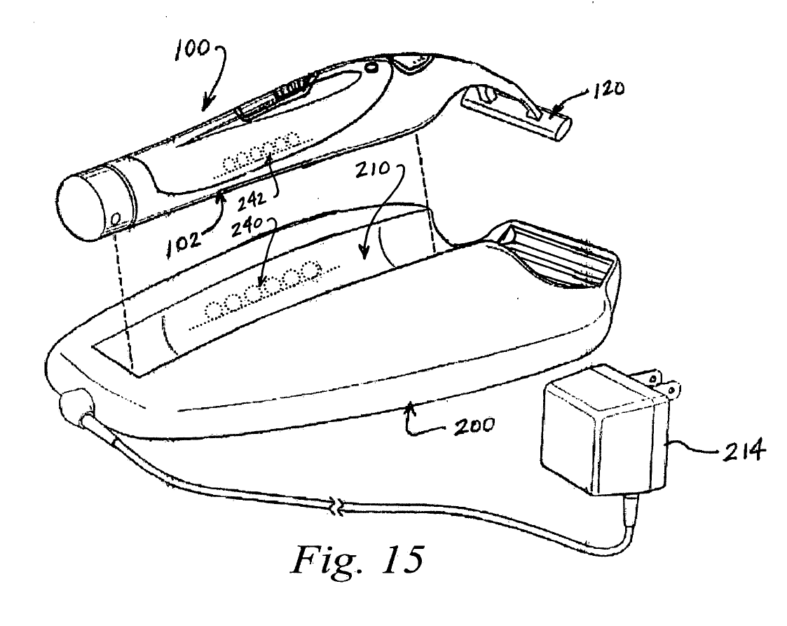

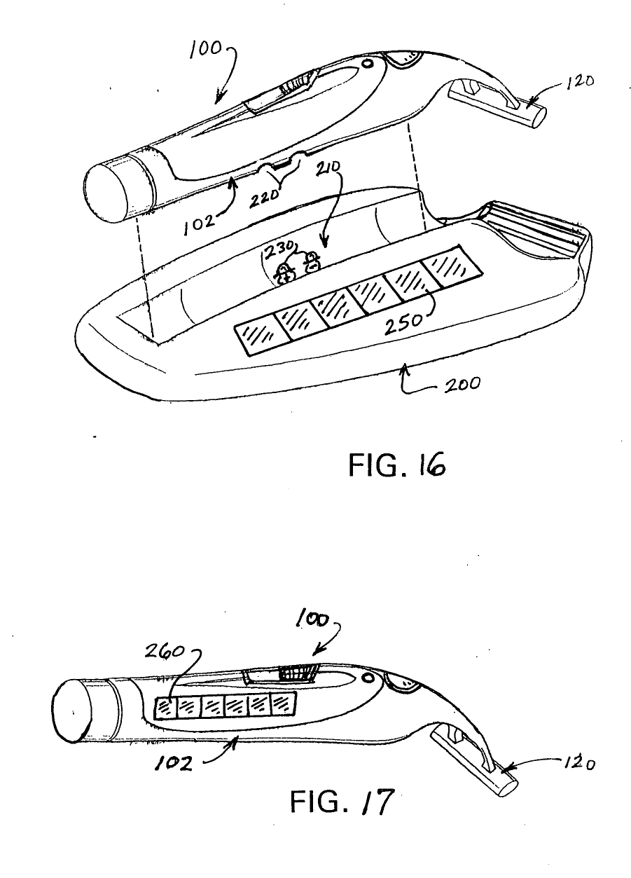

FIGS. 2-3 illustrate a second embodiment of the invention, generally indicated as 100, wherein all of the components of the electric circuit of the blade heating system, with the exception of the one or more blades, are carried in the handle 102 of the razor 100. Specifically, the handle 102 of the razor includes a battery compartment 104 for holding one or more batteries 106. By removing the bottom end 108 of the handle 102, the batteries 106 can be removed and replaced, as needed. It should be noted that rechargeable batteries, such as lithium batteries, may be used to eliminate a voltage drop throughout the life of the battery. Use of rechargeable batteries provides for a steady and consistent voltage source to maintain the adjusted blade heat levels consistent throughout the life of the batteries. FIG. 13 illustrates one embodiment of a battery recharging device in the form of a tray that plugs into an electrical power outlet, such as a 100 volt AC outlet. The tray 200 includes a cradle 210 that is provided with spring loaded contacts 230 that protrude upwardly from the cradle. The spring loaded contacts 230 are correspondingly positioned and aligned for engaging recessed contacts 220 on the handle 102 of the razor 110. A cord with a transformer 214 plugs into a standard 100 volt AC outlet for providing electric power to the contacts 230. When the razor 100 is seated within the cradle, the spring loaded contacts 230 make electrical contact with the recessed contacts 220 on the handle 102 of the razor 100, wherein power is provided to the internal rechargeable battery source to thereby recharge the battery source. FIG. 14 illustrates a further embodiment of the battery recharging device, wherein a cord with a transformer plug 214 plugs into a standard 110 volt AC outlet. A plug 212 on the opposite end of the cord is adapted for connection to a port in the handle of the razor. When the cord is plugged into the outlet and the plug 210 is inserted within the port, electric power is provided to the internal rechargeable battery source for recharging the battery source. FIG. 15 shows a further embodiment of the battery recharging tray 200, wherein inductive couplings 240 and 242 are provided in the cradle 210 of the tray and the handle 102 of the razor for providing a waterproof electrical connection between the tray and the razor in order to recharge the internal rechargeable battery source in the razor. FIG. 16 shows a further embodiment of the battery recharging tray 200, wherein an arrangement of light collecting panels 250 are provided on the tray for collecting light energy and converting the light energy into electric power for recharging the internal rechargeable battery source in the razor when the razor is seated in the cradle of the tray. FIG. 17 shows yet a further embodiment of the battery recharging device, wherein the handle of the razor is provided with an arrangement of light collecting panels 260 for collecting light energy and converting the light energy into electric power for recharging the internal rechargeable battery source in the razor.

The razor 100 in the embodiment of FIGS. 2-3 further includes an ON/OFF switch 110 on the handle for activating and deactivating the blade heating system. In a preferred embodiment, the ON/OFF switch 110 is provided as a single slide switch, which may be of the type that is normally biased to a relaxed position, as shown in FIG. 2. By moving the ON/OFF switch 110, in a sliding downward motion, against a spring biased force, the blade heating system circuit is closed. Subsequent movement of the ON/OFF slide switch 110, in the same action, serves to open the circuit, thereby deactivating the blade heating system. The ON/OFF switch 110 also may be a push button type switch.

A dial 112 or other user controllable device is provided on the handle 102 for adjusting the temperature level of the blades 124 when the blade heating system is ON. Temperature adjustment and control may be achieved by various devices, such as a pulsating switch, self-interrupting reed relays or a rotating motor. The use of a pulsating switch or a rotating motor may further provide a vibration feature which may be desirable when shaving. A visual indicator, such as a single light or multiple lights, may be provided on the handle of the razor to indicate the ON and OFF status of the blade heating system. In one embodiment, a single light indicator 116, such as an LED, may be provided on the handle. In this instance, the single LED may be of the type that changes color when the circuit is open and closed. For example, when the circuit is open (i.e., in an OFF status) the LED 116 might be red in color. Turning the blade heating system on, by closing the circuit, may change the LED 116 to a green color, thereby indicating to the user that the blade heating system has been activated.

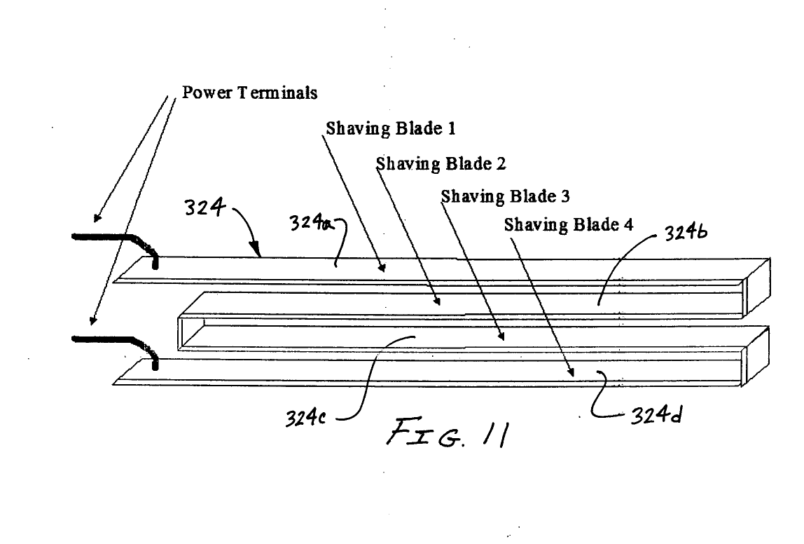

In the embodiment of FIGS. 2-3, the blade cartridge 120, containing one or more blades 124, removably attaches to the top end of the handle to provide an electrical coupling which connects the blades 124 to the blade heating system circuit in the handle 102. Electrical connection of the blade heating system circuit 130 in the handle 102 to the circuit 134 blade cartridge, and particularly the blades 124, may be achieved by prong connectors 140 extending from the connecting members 113, 114 on the top end of the handle 102. The conductive prongs 140 are received within ports 142 or receptacles in the blade cartridge 120. The receptacles 142 are electrically connected to the one or more blades 124 in the blade cartridge. Again, the blades 124 may be connected in parallel, as shown in FIG. 4 or, alternatively, in series, as shown in FIG. 5. In another embodiment, the blade cartridge 120 may be electrically connected to the top end of the handle 102 by an inductive coupling 150, as shown in FIG. 10. In this particular embodiment, the blade heating system circuit 130 in the handle may be provided with a step-down transformer 132. The inductive coupling 150 transfers energy from the blade heating system circuit 130 in the handle to the circuit 134 in the blade cartridge 120 through a shared magnetic field. Specifically, a change in current flow through the circuit 130 in the handle 102 induces current flow in the circuit 134 of the blade cartridge as a result of the close, spaced relation at the inductive coupling 150, wherein both circuits are within a shared magnetic field. It is important to note that an inductive coupling of this nature provides the benefit of a completely water-tight electrical connection between the blade cartridge circuit 134 and the electric circuit 130 within the handle 102 of the razor 100.

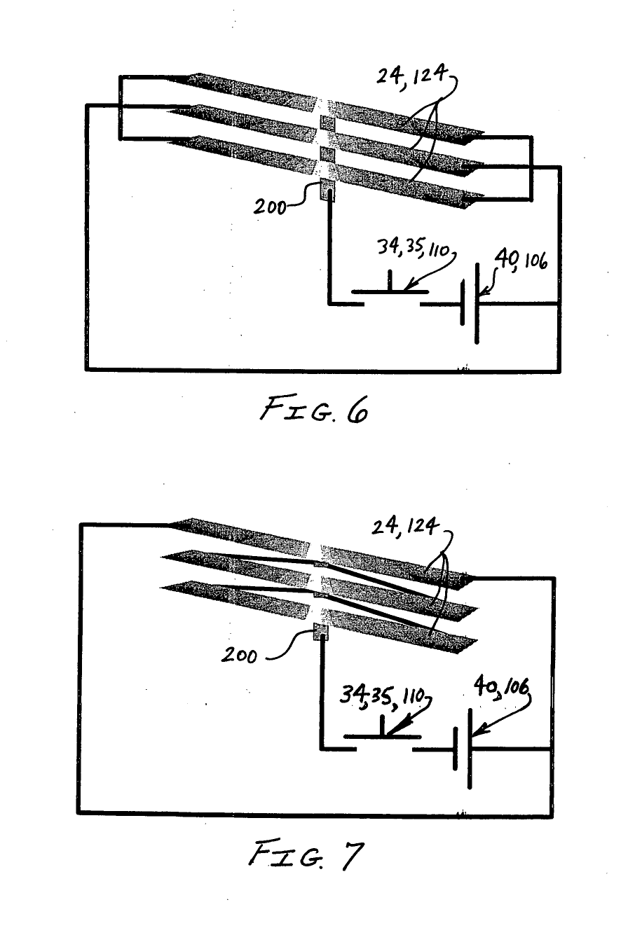

FIGS. 6 and 7 illustrate a further embodiment of the electrical connection of the blades (24, 124) in the blade cartridge through a center tap connection 200. Specifically, FIG. 6 shows three blades in the blade cartridge connected in parallel through a center tap connection 200. FIG. 7 shows the three blades in the blade cartridge connected in series through a center tap connection 200. Use of a center tap connection 200 may be beneficial to provide consistent heat levels across the entire length of the blades.

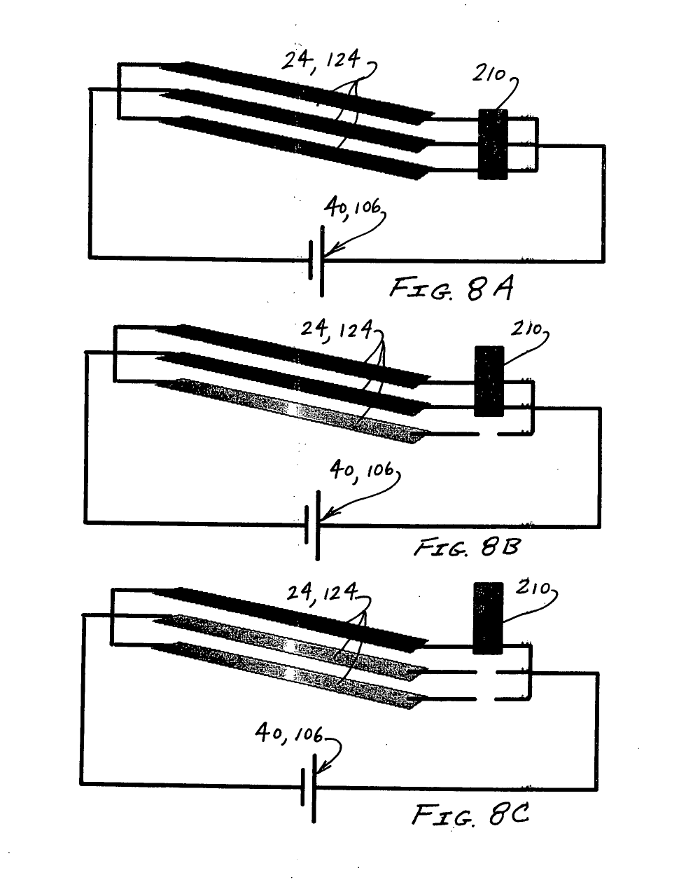

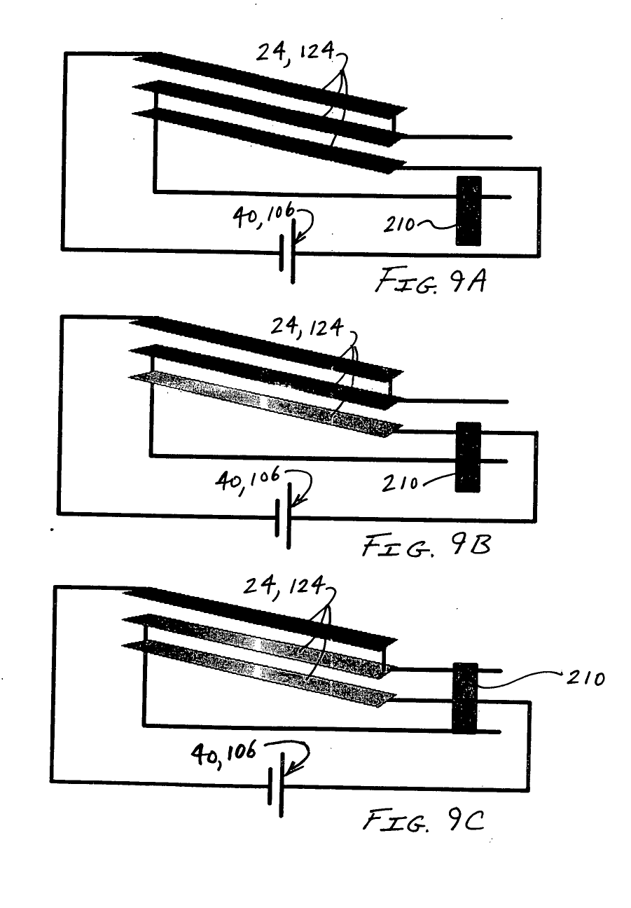

FIGS. 8A-8C illustrate an example of a slide switch control 210 for adjustably controlling the temperature level of the blades (24, 124), wherein the blades (24, 124) in the blade cartridge (20, 120) are connected in parallel. In this example, FIG. 8A shows the slide switch 210 completely closing the parallel connection of the three blades so that current flow is directed through all three of the blades rendering the lowest resistance, thereby providing the hottest temperature levels. FIG. 8B slows the slide switch 210 moved to disconnect the lower blade from the circuit, so that current flow is only directed through the middle blade and the top blade rendering medium resistance. This produces a medium level of heat. FIG. 8C shows the slide switch 210 moved to a third position, wherein the middle blade and the bottom blade are disconnected from the circuit so that current flow is only directed through the top blade rendering the highest resistance, thereby producing a temperature level that is not as hot as achieved in the slide switch positions of FIGS. 8A and 8B.

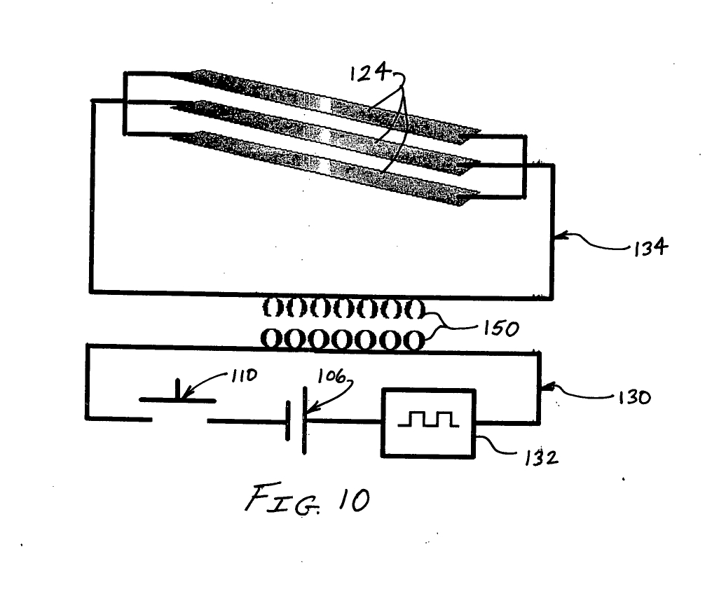

FIGS. 9A-9C illustrate a sequence of operation of a slide switch 210 to control blade temperature levels with the blades connected in series. In this example, FIG. 9A shows the slide switch 210 moved to the maximum resistance three blades in series low temperature position. In FIG. 9B, the slide switch 210 is moved to the medium resistance wherein two blades are connected in series to define a medium temperature position. FIG. 9C shows the slide switch moved to the minimum resistance wherein only one blade is in series to define the hottest temperature adjusted position.

FIG. 11 shows a further embodiment of the blade configuration, wherein a continuous conductive blade 324 is folded into four parallel blades segments, 324a-324d. Each end of this continuous folded blade configuration is connected, via a conductor, to one of the terminals of the battery, to provide current flow through all four blade segments.

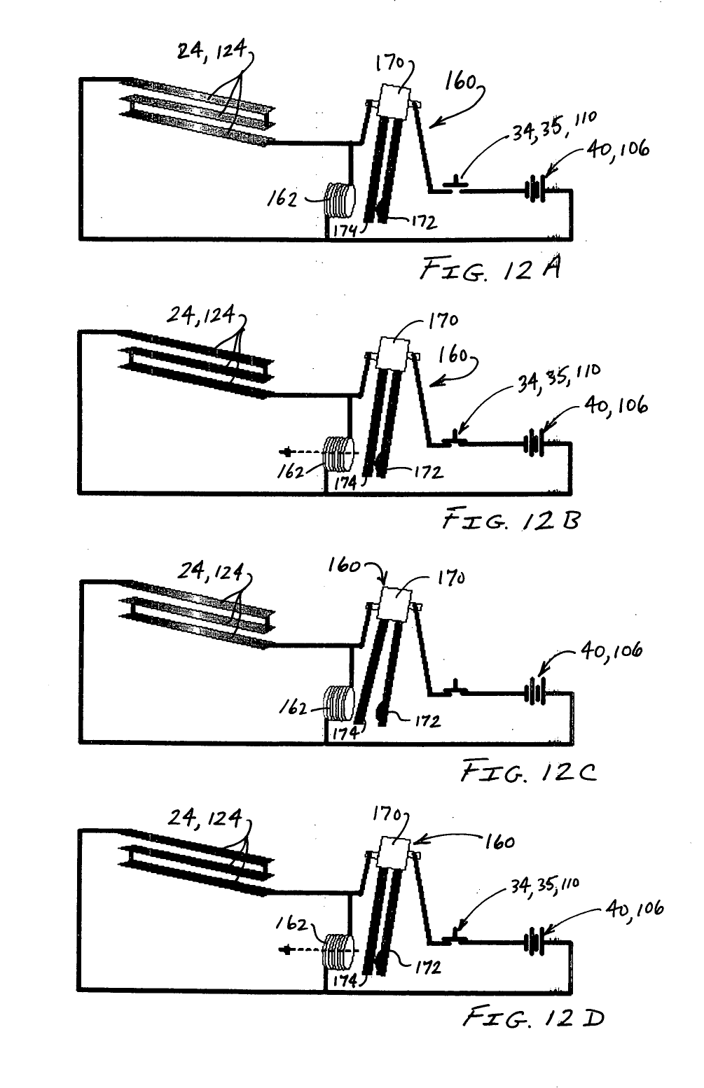

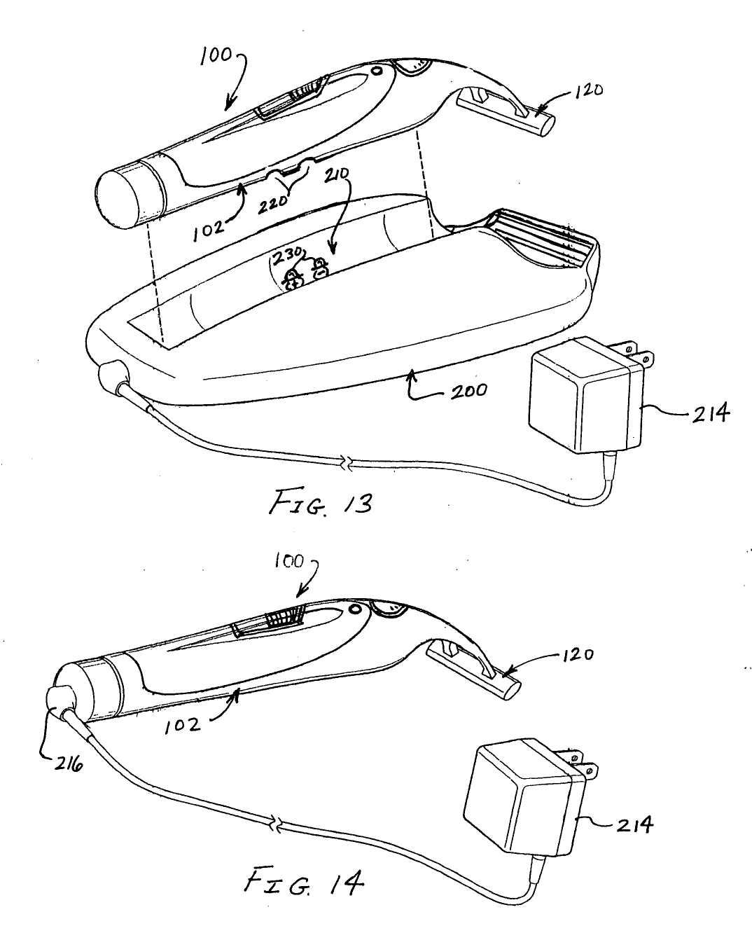

FIGS. 12-12D illustrate a sequence of operation of a pulsating switch 160 as an example of one embodiment for providing for adjusted control of the blade heat level. In the example shown in FIGS. 12A-12D, three blades are connected in series. In FIG. 12A, the switch 110 is open (i.e., OFF), and thus the circuit is open. FIG. 12B shows the switch 110 closed, to turn the blade heating system ON, completing current flow through the three blades, and thereby causing the blades to be heated. In FIG. 12C, coil relay 162 is activated to separate the reed contacts 172, 174 of the reed relay switch 170, thereby temporarily interrupting current flow to the blades 124. Thereafter, in FIG. 12D, the relay coil 162 is deactivated to allow the reed contacts 172, 174 to close, thereby closing the reed relay 170 and permitting current flow through the blades 124. The timing of this cycle of opening and closing the reed relay switch can be adjusted, to thereby control the amount of time that current flow is directed through the blades, thereby effectively controlling the temperature level of the blades.

In each of the embodiments described above, and particularly the first embodiment of FIGS. 1-1B and the second embodiment of FIGS. 2-3, a slide switch or pressure actuated switch 34, 35 may be substituted for a proximity switch. More specifically, a proximity switch would allow the current flow to the blades upon contact of the blades with the user's skin. In this particular embodiment, the proximity switch acts as a capacitive and resistive sensing circuit that senses a difference in resistance or capacitance when the blades come in contact with the skin. Another embodiment may employ a contact switch or other type switch that closes when the blade cartridge pivots in response to pressure against the user's skin. The use of a proximity switch or other types of switches of this nature, in order to activate the blade heating system, serves as a highly effective means for preserving battery life. Other battery preserving measures include use of a timer, tilt switch or other device, as described above, for opening the circuit in the event the user fails to turn the blade heating system off after shaving.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. A razor comprising:
a handle including a top end;
a blade cartridge adapted for attachment to the top end of said handle and containing at least one electrically conductive blade;
conductors connecting said at least one blade to an electric power storage source for delivering electric current to said at least one blade, wherein flow of the electric current through said least one blade causes said blade to be heated;
a switch selectively operable between an ON status for allowing the electric current flow through said at least one blade and an OFF status for interrupting the electric current flow through said at least one blade;
a control system for selectively controlling an amount of electric current flowing through said at least one blade and thereby selectively controlling the heated temperature of said at least one blade; and
a visual indicator for indicating the ON and OFF status of said switch.

2. The razor as recited in claim 1 wherein said blade cartridge contains a plurality of said electrically conductive blades.

3. The razor as recited in claim 2 wherein said conductors are connected to allow the electric current flow through each of said plurality of electrically conductive blades.

4. The razor as recited in claim 3 wherein said plurality of electrically conductive blades are electrically connected in parallel arrangement.

5. The razor as recited in claim 3 wherein said plurality of electrically conductive blades are electrically connected in series arrangement.

6. The razor as recited in claim 1 wherein said visual indicator includes at least one LED.

7. The razor as recited in claim 6 wherein said at least one LED is adapted to change color in order to visually distinguish both said ON status and said OFF status.

8. The razor as recited in claim 2 wherein said switch is a slide switch for selectively controlling the electric current flow through one or more of said plurality of electrically conductive blades.

9. The razor as recited in claim 2 wherein said switch is a proximity switch structured to allow the electric current flow through at least one of said plurality of electrically conductive blades upon contact of at least one of the plurality of electrically conductive blades with a user's skin.

10. The razor as recited in claim 1 further comprising:
a rechargeable battery for providing the electric power storage source.

11. A razor comprising:
a handle including a top end;
a blade cartridge adapted for attachment to the top end of said handle and containing at least one electrically conductive blade;
said at least one blade connectable to an electric power storage source for delivering electric current to said at least one blade, wherein flow of the electric current through said least one blade causes said blade to be heated;
a switch selectively operable between an ON status for allowing the electric current flow through said at least one blade and an OFF status for interrupting the electric current flow through said at least one blade;
a control system for selectively controlling the heated temperature of said at least one blade; and
a visual indicator for indicating the ON and OFF status of said switch.

12. The razor as recited in claim 11 wherein said blade cartridge contains a plurality of said electrically conductive blades.

13. The razor as recited in claim 12 wherein said plurality of said electrically conductive blades are connected to allow the electric current flow through each of said plurality of electrically conductive blades.

14. The razor as recited in claim 13 wherein said plurality of electrically conductive blades are electrically connected in parallel arrangement.

15. The razor as recited in claim 13 wherein said plurality of electrically conductive blades are electrically connected in series arrangement.

16. The razor as recited in claim 12 wherein said switch is a slide switch for selectively controlling the electric current flow through one or more of said plurality of electrically conductive blades.

17. The razor as recited in claim 12 wherein said switch is a proximity switch structured to allow the electric current flow through at least one of said plurality of electrically conductive blades upon contact of at least one of the plurality of electrically conductive blades with a user's skin.

18. The razor as recited in claim 11 further comprising:
a rechargeable battery for providing the electric power storage source.

19. The razor as recited in claim 11 further comprising:
a temperature indicator for indicating the heated temperature of said at least one blade.

20. A razor comprising:
a handle including a top end;
a blade cartridge adapted for attachment to the top end of said handle and containing at least one electrically conductive blade;
an electric power storage source carried on said blade cartridge for delivering electric current to said at least one blade, wherein flow of the electric current through said least one blade causes said blade to be heated;
a switch selectively operable between an ON status for allowing the electric current flow through said at least one blade and an OFF status for interrupting the electric current flow through said at least one blade;
a control system for selectively controlling the heated temperature of said at least one blade; and
a temperature indicator for indicating the heated temperature of said at least one blade.

21. The razor as recited in claim 20 wherein said switch is on said blade cartridge.

22. The razor as recited in claim 20 wherein said control system is on said blade cartridge.

23. The razor as recited in claim 20 wherein said temperature indicator is on said blade cartridge.

24. The razor as recited in claim 20 further comprising:
a visual indicator for indicating the ON and OFF status of said switch.

25. The razor as recited in claim 20 wherein said blade cartridge contains a plurality of said electrically conductive blades.

26. The razor as recited in claim 24 wherein said visual indicator includes at least one LED.

27. A razor comprising:
a handle including a top end;
a blade cartridge adapted for attachment to the top end of said handle and containing at least one electrically conductive blade;
an electric power storage source within said handle;
conductors connecting said at least one blade to said electric power storage source for delivering electric current to said at least one blade, wherein flow of the electric current through said least one blade causes said blade to be heated;
a switch on said handle selectively operable between an ON status for allowing the electric current flow through said at least one blade and an OFF status for interrupting the electric current flow through said at least one blade;
a control system for selectively controlling the heated temperature of said at least one blade; and
a temperature indicator for indicating the heated temperature of said at least blade.

28. The razor as recited in claim 27 wherein said blade cartridge contains a plurality of said electrically conductive blades.

29. The razor as recited in claim 27 further comprising:
a visual indicator for indicating the ON and OFF status of said switch.

30. The razor as recited in claim 29 wherein said visual indicator includes at least one LED.

31. The razor as recited in claim 27 further comprising:
an inductive coupling between said handle and said blade cartridge for electrically connecting said at least one electrically conductive blade to said electric power storage source.

32. The razor as recited in claim 28 wherein said switch is a slide switch for selectively controlling the electric current flow through one or more of said plurality of electrically conductive blades.

33. The razor as recited in claim 28 wherein said switch is a proximity switch structured to allow the electric current flow through at least one of said plurality of electrically conductive blades upon contact of at least one of the plurality of electrically conductive blades with a user's skin.

34. The razor as recited in claim 27 further comprising:
a rechargeable battery for providing the electric power storage source.
